(19) United States
(12) Patent Application Publication
(10) Pub. No.: US 2021/0380810 A1
(43) Pub. Date: Dec. 9, 2021

(54) Organic Composition for Treating Roads

(71) Applicant: Joseph C. Rouleau, Suffield, CT (US)

(72) Inventor: Joseph C. Rouleau, Suffield, CT (US)

(21) Appl. No.: 16/896,677

(22) Filed: Jun. 9, 2020

(51) Int. Cl. C08L 97/02

(52) U.S. Cl. CPC C08L 97/02; E01C 23/08

(57) ABSTRACT

A composition for treating roads includes a substrate having a coarse texture and being formed from fibers of wood, wood pulp, bamboo, sugar cane, or a combination thereof. The fibers each have a length less than about 25 mm (about 1 inch). The composition further includes an organic solution generated as a waste stream byproduct of a food-processing operation or the distillation of an alcohol. The substrate is at least partially saturated with the organic solution and has a freezing point in the range of −25° Celsius (−13° Fahrenheit) to −35° Celsius (−30° Fahrenheit). The composition may further include a salt or brine solution including two-to-five parts-by-volume of the at least partially saturated substrate, respectively, to eight-to-five parts-by-volume of the salt or brine solution, respectively, thereby resulting respectively in a 20% to 50% modified brine solution.

### TECHNICAL FIELD

The present invention is directed to an organic composition for treating roads. More particularly, the invention comprises an organic substrate and solution for treating roads having ice or snow thereon and for providing traction for vehicles travelling thereon.

### BACKGROUND OF THE INVENTION

Roads often become coated with snow, ice and other forms of freezing precipitation which makes travelling thereon unsafe and even treacherous at times. The surface of such roads may be covered by a thin coating of ice, commonly referred to as black ice, which is substantially transparent and therefore likely to be unnoticeable to drivers. Thus, there is a risk of skidding and subsequent accident due to the unexpected loss of traction of the vehicle travelling on such roads.

Federal, state and municipal government agencies, such as various Departments of Transportation, undertake road treatment programs to reduce the hazards caused by freezing precipitation. Such programs typically include treating the road surface with, or spraying onto the road surface, a solution designed to lower the freezing point of water. Such solutions often include various chloride-based compounds such as salts or brine solutions. Sodium chloride, commonly referred to as rock salt, is commonly used. The freezing point of the precipitation on a road surface is lowered once the salt is added. For example, a 10-percent salt solution freezes at −6° Celsius (20° Fahrenheit), and a 20-percent salt solution freezes at −16° Celsius (2° Fahrenheit). Thus, typical road treatments are not effective at temperatures below these points. Moreover, such solutions cause corrosion, e.g., by rusting the steel used in most vehicles and the rebar in concrete bridges. In some concentrations, such solutions are toxic to some plants and animals. Solutions commonly used to treat roads include calcium chloride, magnesium chloride and potassium chloride, all of which negatively impact the environment.

### SUMMARY

In one aspect, the present invent is directed to a composition for treating roads, the composition comprising: a substrate having a coarse texture and being formed from fibers of wood, wood pulp, bamboo, sugar cane, or a combination thereof, the fibers each having a length less than about 25 mm (about 1 inch); and an organic solution generated as a waste stream byproduct of a food-processing operation or the distillation of an alcohol; wherein: the substrate is at least partially saturated with the organic solution; and the composition has a freezing point in the range of −25° Celsius (−13° Fahrenheit) to −35° Celsius (−30° Fahrenheit).

In one embodiment, the organic solution comprises molasses, a fructose pulp, a cellulose, or a combination thereof. In one embodiment, the substrate is saturated with the organic solution. In one embodiment, the composition has a freezing point of about −35° Celsius (−30° Fahrenheit).

In one embodiment, the composition includes a salt or brine solution including two-to-five parts-by-volume of the at least partially saturated substrate, respectively, to eight-to-five parts-by-volume of the salt or brine solution, respectively, thereby resulting respectively in a 20% to 50% modified brine solution. In one embodiment, the composition includes a salt or brine solution including seven parts-by-volume of the composition to three parts-by-volume of the salt or brine solution thereby resulting in a 70% modified brine solution.

In one aspect, the present invent is directed to a method for treating roads, the method comprising: preparing a composition having a freezing point in the range of −25° Celsius (−13° Fahrenheit) to −35° Celsius (−30° Fahrenheit), the composition including, a substrate having a coarse texture and being formed from fibers of wood, wood pulp, bamboo, sugar cane, or a combination thereof, the fibers each having a length less than about 25 mm (about 1 inch), and an organic solution generated as a waste stream byproduct of a food-processing operation or the distillation of an alcohol; at least partially saturating the substrate with the organic solution; and dispersing the composition on a road surface.

### DETAILED DESCRIPTION OF THE PREFERRED EMBODIMENTS

As used herein, the term “organic” is used with reference to its ordinary conventional definition, namely, “relating to or derived from living matter.” For clarity, the use of the term “organic” herein does not indicate that a substrate of the present invention is or constitutes a food, beverage or agricultural product that has been produced through approved methods, or is in compliance with laws, rules or standards therefor, such as for example, the Organic Food Production Act, the United States Department of Agriculture organic regulations, and the National Organic Program Handbook (i.e., 7 U.S.C. § 6501, et. seq.; 7 C.F.R. Part 205; and “The Program Handbook: Guidance and Instructions for Accredited Certifying Agents and Certified Operations”).

The present invention provides a composition for treating roads subject to being coated with snow, ice and other forms of freezing precipitation, collectively referred to herein as an “unsafe coating,” to make travelling on such roads less hazardous by minimizing the risk of an unexpected loss of traction of a vehicle travelling thereon. The use of an organic substrate and solution for preparation of the composition in accordance with the present invention substantially reduces the negative impacts on the environment caused by the use of typical brine solutions containing compounds such as sodium chloride, calcium chloride, magnesium chloride and potassium chloride, and other chloride-based compounds. In one embodiment, the use of the organic substrate and solution of the present invention reduces the use of a typical brine solution by seventy percent (70%).

The present invention includes providing an organic substrate and solution for use in preparing a brine mixture to be dispersed on, or applied to, the surface of a road. The organic substrate has a suitably coarse texture that promotes tire traction on a road surface that may be glazed with an unsafe coating. The suitably coarse texture of the substrate is characteristically abrasive to the unsafe coating on the road surface. Such substrates having the requisite coarse texture are granular, grainy, gritty, and the like. Such substrates provide longer residual effects when spread on roadways than a typical brine solution.

In one embodiment, the composition includes substrates formed from wood, wood pulp, bamboo, sugar cane, or a combination of such materials. In one embodiment, the substrate is collected and processed or ground to a size suitable for dispensing onto a road surface, referred to herein as a “processed substrate.” In one embodiment, the size of the processed substrate relates to a length of a representative fiber of the processed substrate. In one embodiment, the length of the representative fiber is less than about 25 mm (about 1 inch). In one embodiment, the length of the representative fiber is greater than about 13 mm (about 0.5 inch) and less than about 25 mm (about 1 inch).

The processed substrate is mixed with an organic solution to form the composition of the present invention. In one embodiment, the organic solution is generated as a waste stream material or byproduct of an agricultural or food-processing operation or the distillation of an alcohol. In one embodiment, the byproduct is a viscous product resulting from refining sugarcane or sugar beets into sugar, the byproduct being commonly referred to as molasses. In one embodiment, the byproduct is a fructose pulp resulting from refining vegetables and fruit for consumption as, for example, baby food. In one embodiment, the byproduct is a cellulose resulting from refining vegetables and other plant substances. In one embodiment, the byproduct is a dried grain or dried grain-yeast mixture resultant from the alcohol fermentation process. In one embodiment, the organic solution is a combination of any of the foregoing byproducts.

In one embodiment, the composition of the present invention includes the processed substrate being partially saturated with the organic solution. In one embodiment, the composition of the present invention includes the processed substrate being saturated with the organic solution. The processed substrate being at least partially saturated with the byproduct solution promotes a longer contact-period of the composition with a road surface and a greater dispersion of the composition on the road surface.

In one embodiment, the at least partially saturated substrate is further mixed with salt or a brine solution to provide a more environmentally-friendly mixture for treating the unsafe coating on the road surface than rock salt, the mixture referred to herein as a “modified brine solution.” The composition serves as a carrier for the salt or brine solution to the road surface and promotes a longer contact-period of the salt or brine solution with the road surface, a greater dispersion of the salt or brine solution on the road surface, and safer driving conditions on the road. Thus, less salt or brine solution is applied to the road surface thereby lowering the cost of treatment of the roads. Moreover, less salt or brine solution is washed away from the road surface and passed to a storm water collection system.

In one embodiment, the modified brine solution includes seven parts-by-volume of the composition to three parts-by-volume of the salt or brine solution, thereby resulting in a 70% modified brine solution. In one embodiment, the modified brine solution includes two-to-five parts-by-volume of the composition, respectively, to eight-to-five parts-by-volume of the salt or brine solution, thereby resulting respectively in a 20% to 50% modified brine solution. Other embodiments of the modified brine solution of the present invention include modified brine solutions having mixing ratios resulting in less than a 20% modified brine solution, greater than a 50% modified brine solution, and greater than a 70% modified brine solution.

The modified brine solution of the present invention weighs substantially less than a typical rock salt or brine solution. In one embodiment, the modified brine solution weighs approximately one-third of the weight of the rock salt or brine solution. For example, one cubic yard of rock salt weighs approximately one ton (1 m³ of rock salt weighs approximately 1290 kg; and 1 yd.³ of rock salt weighs approximately 2,160 lbs.). In one embodiment, the modified brine solution weighs about 420 kg/m³ (about 700 lbs./yd.³). Thus, one road maintenance vehicle having a specified weight limit can carry three times the volume of the modified brine solution in comparison to rock salt (provided the vehicle has the volume capacity to do so). The lower weight of the modified brine solution enables road maintenance vehicles to treat three times as many miles of road surface with one load of material than maintenance vehicles carrying typical road treatment materials or solutions. In one embodiment, the modified brine solution weighs in the range of about 300 kg/m³ (about 500 lbs./yd.³) to about 600 kg/m³ (about 1000 lbs./yd.³).

In accordance with a method for preparing a modified brine solution for treating roads, a substrate having a coarse texture is provided. The substrate is ground and the ground substrate is mixed with a byproduct of an agricultural or food-processing operation or the distillation of an alcohol. The substrate and byproduct mixture is stored until the mixture is selected for use. The substrate and byproduct mixture is then mixed with salt or a brine solution as described hereinabove.

The composition of the present invention provides for greater adhesion to a road surface than rock salt. Such greater adhesion enables the composition to withstand more than one weather event, or winter storm, such that even less rock salt is used to treat roads having an unsafe coating thereon. Moreover, the composition of the present invention dissolves into topsoil thereby substantially reducing the environmental impact of the use of road salt.

In contrast to the freezing point of a 20-percent salt solution of −16° Celsius (2° Fahrenheit), the composition of the present invention has a freezing point as low as −35° Celsius (−30° Fahrenheit). In one embodiment, the composition of the present invention has a freezing point in the range of about −25° Celsius (about −13° Fahrenheit) to about −35° Celsius (about −30° Fahrenheit). Accordingly, the composition of the present invention provides for a substantially greater range of use of the composition than rock salt in reducing the hazards caused by freezing precipitation.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above-detailed description, but that the invention will include all embodiments falling within the scope of the appended claims.

What is claimed is:

1. A composition for treating roads, the composition comprising:
a substrate having a coarse texture and being formed from fibers of wood, wood pulp, bamboo, sugar cane, or a combination thereof, the fibers each having a length less than about 25 mm (about 1 inch); and
an organic solution generated as a waste stream byproduct of a food-processing operation or the distillation of an alcohol;
wherein:
the substrate is at least partially saturated with the organic solution; and
the composition has a freezing point in the range of −25° Celsius (−13° Fahrenheit) to −35° Celsius (−30° Fahrenheit).

2. The composition of claim 1, the organic solution comprising molasses, a fructose pulp, a cellulose, or a combination thereof.

3. The composition of claim 1, wherein the substrate is saturated with the organic solution.

4. The composition of claim 1, wherein the composition has a freezing point of about −35° Celsius (−30° Fahrenheit).

5. The composition of claim 1, the composition further comprising:
a salt or brine solution;
wherein the composition includes two-to-five parts-by-volume of the at least partially saturated substrate, respectively, to eight-to-five parts-by-volume of the salt or brine solution, respectively, thereby resulting respectively in a 20% to 50% modified brine solution.

6. The composition of claim 1, the composition further comprising:
a salt or brine solution;
wherein the composition includes seven parts-by-volume of the at least partially saturated substrate composition to three parts-by-volume of the salt or brine solution thereby resulting in a 70% modified brine solution.

7. A method for treating roads, the method comprising:
preparing a composition having a freezing point in the range of −25° Celsius (−13° Fahrenheit) to −35° Celsius (−30° Fahrenheit), the composition including,
a substrate having a coarse texture and being formed from fibers of wood, wood pulp, bamboo, sugar cane, or a combination thereof, the fibers each having a length less than about 25 mm (about 1 inch), and
an organic solution generated as a waste stream byproduct of a food-processing operation or the distillation of an alcohol;
at least partially saturating the substrate with the organic solution; and
dispersing the composition on a road surface.

8. The method of claim 7, further comprising:
formulating the organic solution with molasses, a fructose pulp, a cellulose, or a combination thereof.

9. The method of claim 7, further comprising:
saturating the substrate with the organic solution.

10. The method of claim 7, further comprising:
providing a composition having a freezing point of about −35° Celsius (−30° Fahrenheit).

11. The method of claim 7, further comprising:
mixing the composition with a salt or brine solution thereby forming a modified brine solution including two-to-five parts-by-volume of the composition, respectively, to eight-to-five parts-by-volume of the salt or brine solution, respectively, thereby resulting respectively in a 20% to 50% modified brine solution.

12. The method of claim 7, further comprising:
mixing the composition with a salt or brine solution thereby forming a modified brine solution including seven parts-by-volume of the composition to three parts-by-volume of the salt or brine solution thereby resulting in a 70% modified brine solution.
